(19) United States
(12) Patent Application Publication
(10) Pub. No.: US 2010/0291351 A1
(43) Pub. Date: Nov. 18, 2010

(54) WALLBOARD TAPE

(76) Inventor: John S. Conboy, Chesterfield, MO (US)

Correspondence Address: Polster, Lieder, Woodruff & Lucchesi, L.C., 12412 Powerscourt Dr. Suite 200, St. Louis, MO, 63131-3615, US

(21) Appl. No.: 12/844,009

(22) Filed: Jul. 27, 2010

Related U.S. Application Data
(63) Continuation-in-part of application No. 11/271,623, filed on Nov. 12, 2005.

(51) Int. Cl. B32B 3/16; B32B 3/30; B32B 3/10; B32B 3/14

(52) U.S. Cl. 428/174; 428/191; 428/177; 428/138

(57) ABSTRACT

A wallboard tape having a base layer of paper tape having two parallel outer edges and two strips of paper tape applied to the base layer and parallel to the outer edges with an adhesive material. The strips are separated by a gap.

### FIELD OF THE INVENTION

This invention relates to wallboard tape. More particularly the present invention relates to wallboard tape including two strips of tape overlaying a portion of one surface of a base tape and separated by a gap.

### BACKGROUND OF THE INVENTION

Paper wallboard tape tends to absorb water and soften when applied over normal amounts of compound as is necessary when taping joints and corners. When the paper tape dries, it sags and deforms and a straight line corner is not achieved. Thus, paper tape must be applied over thin layers of compound which requires a number of coats of compound or the imperfections must be pre-filled, increasing labor costs and time to finish. Paper tape does, however, provide good adherence to the compound but must be coated with a thin layer of compound or paint can and will release from the paper surface by blistering or bubbling and sandpaper finishing will scuff the paper if it is not coated with compound.

Wallboard tape made from polyvinyl chloride (“PVC”) is known. While PVC tape provides very straight and durable corner beads and seam joints for wallboard installations, the challenge with PVC is to get a strong adherence of the wallboard compound to the PVC tape.

One such product, by the inventor of the present invention, is shown in U.S. Pat. No. 5,418,027, issued to John S. Conboy (the '027 patent), the contents of which are incorporated herein by reference. In the '027 patent, a plastic wallboard tape has a raised center section and outwardly extending wing areas having a coating of fibers adhered to both sides. The raised center of the tape is weakened at the top to cause the tape to crease in a straight line when it is folded at an inside or outside corner to define a straight edge at the corner joint. The combination of the rigid water impervious tape and the fibers allows the tape to be applied over imperfectly fitted wallboard joints with large imperfections because the fibers will achieve a mechanical bond with the wallboard compound or other joint materials, allowing a slow cure, and the tape will not be softened by the compound.

While the invention of the '027 patent greatly improves the adherence of wallboard compound to PVC tape, PVC is an expensive wallboard tape component which is not justified in every installation. However, paper-based wallboard tape is insufficient for many installations, particularly for use on exterior or interior corners. The present invention represents an improvement in paper wallboard tape, particularly for interior or exterior corners.

### SUMMARY OF THE INVENTION

The present invention comprises a wallboard tape having a base layer of paper tape having two parallel outer edges and two strips of paper tape bonded to and overlaying a portion of and applied to one surface of the base layer, said strips of paper tape being parallel to the outer edges and separated by a gap.

### DESCRIPTION OF THE DRAWINGS

In the accompanying drawings which form part of the specification and wherein like numbers and letters refer to like parts wherever they occur

FIG. 1 is a fragmentary plan view of a length of wallboard tape according to an embodiment of the present invention;

FIG. 2 is an end view of a length of wallboard tape according to an embodiment of the present invention;

FIG. 3 is an enlarged partial end view of a length of wallboard tape according to an embodiment of the present invention;

FIG. 4 is another enlarged partial end view of a length of wallboard tape according to an embodiment of the present invention;

FIG. 5 is another enlarged partial plan view of a length of wallboard tape according to an embodiment of the present invention;

FIG. 6 is an end view of a length of wallboard tape according to another embodiment of the present invention;

FIG. 7 is an end view of a corner bead according to an embodiment of the present invention; and

FIG. 8 is an end view of a length of wallboard tape according to an embodiment of the present invention; and

FIG. 9 is a fragmentary plan view of a length of wallboard tape according to an embodiment of the present invention.

### DETAILED DESCRIPTION OF THE PREFERRED EMBODIMENT

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. The scope of the present invention is intended to be limited only by the explicit terms of the claims.

The present invention comprises an improvement in composite paper-based wallboard tape. Specifically, in the preferred embodiment of the invention, the tape comprises a base tape layer and one or more paper strips that are bonded to and overlay at least a portion of the base tape and are preferably located along the length of the tape. The paper strips can be provided in one or more layers.

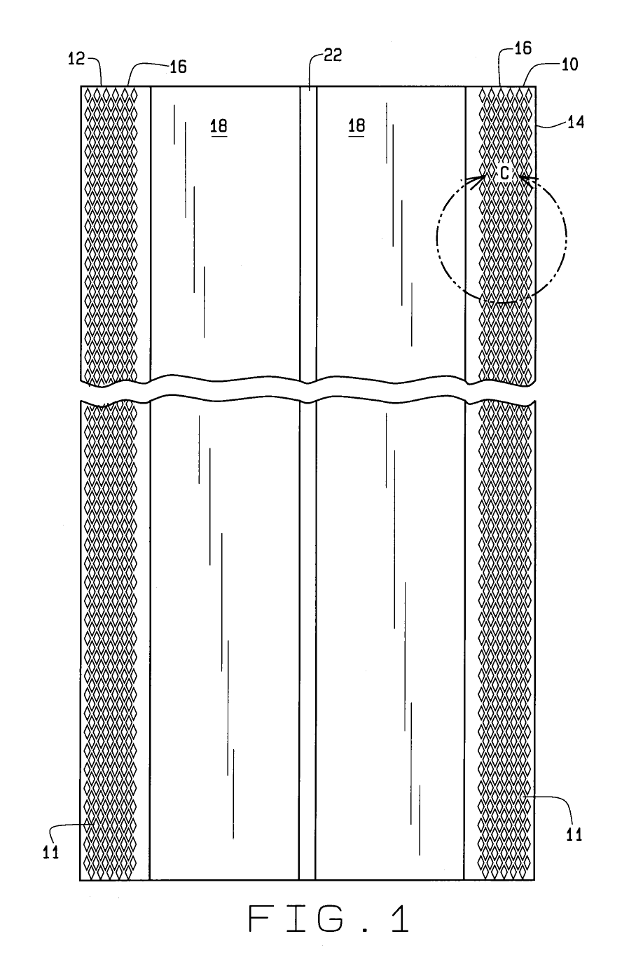

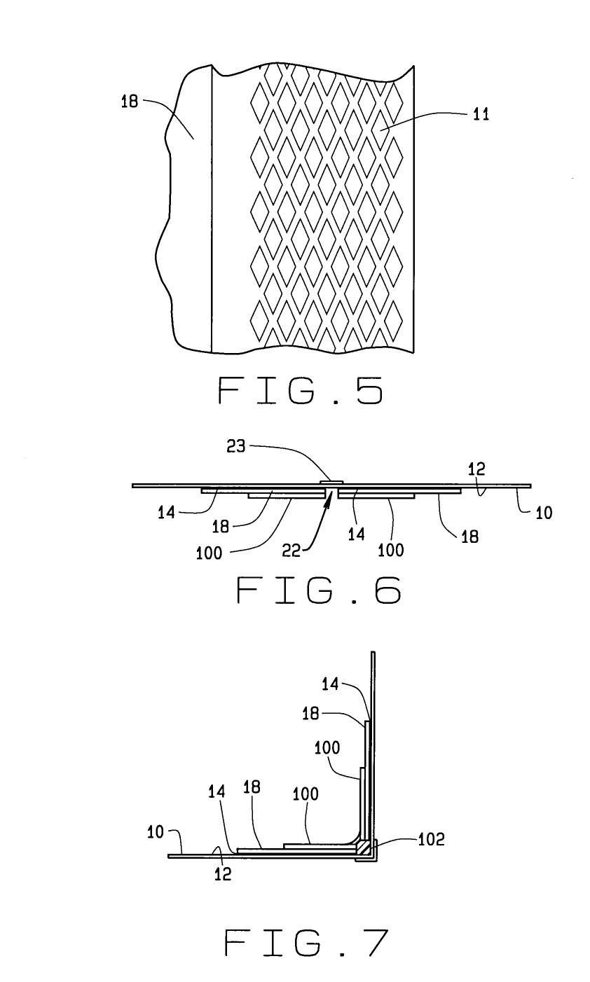

In that regard and referring to FIGS. 1-5, a preferred embodiment of the present invention is shown. The embodiment comprises a paper-based wallboard tape having a base layer of tape 10. The base layer 10 preferably defines a plurality of raised nodules 11 formed by tiny perforations or deformations of the base layer created by the use of a die. The raised nodules 11 allow joint compound to more quickly dry and provide better adherence of the joint compound to the tape. The raised nodules 11 preferably are diamond shaped perforations that deform but do not visibly tear the base layer 10 of the tape, though paper fibers are broken on a microscopic level such that moisture will more readily pass through the base layer 10 of tape at the point of the nodules 11. There are two key aspects to the nodules 11. The first is a resulting increase in surface area and concurrent thinning of the base layer of tape 10 to enhance water evaporation through the base layer of tape 10 from the underlying drywall compound when the tape is installed. Second, the recesses formed by the nodules 11 acts to anchor the paper to provide greater surface area for the drywall compound to bond to the paper. As shown in the drawings, the nodules 11 should, preferably will, extend from the surface of the base layer of tape 10 on which the paper strips are applied. Nodules 11 protruding from the opposite face will cause the paper to sit away from the wallboard. The nodules 11 also prevent excessive removal of drywall compound during installation of the tape 10 that occurs when an installer forces too much joint compound from between the tape 10 and the wall on which it is being installed. The raised nodules 11 preferably are in the form of a strip along and continue to the edge of the tape 10 so that the tape edges are interrupted by the raised nodules 11. The strip of nodules is preferably from about 0.25 to about 0.5 inches wide, preferably about 0.4375 inches wide. The nodules 11 are preferably raised about 0.020 of an inch above the surface of the base layer 10 and are spaced about 0.0625 inches from one another in alternating rows as shown in FIG. 5.

The nodules may be in a strip offset from the edge of the tape but preferably extend to and include the edge of the tape. By having the nodules at the edges as well, this creates a discontinuous edge to the tape which prevents or reduces paper cuts to the installer.

Applied to a top surface 14 of the tape is a protective layer 15 comprising a scuff resistant-water-based styrene acrylic material. The thickness of the protective layer 15 is preferably only a few thousandths thick. This material protects the tape 10 from sanding during installation and also forms a layer that can accept paint.

Applied to and overlaying the length of the bottom surface 12 of the tape 10 are two paper strips 18. The strips 18 are preferably adhered with an adhesive comprising a hot melt, a urethane or a polyamid material.

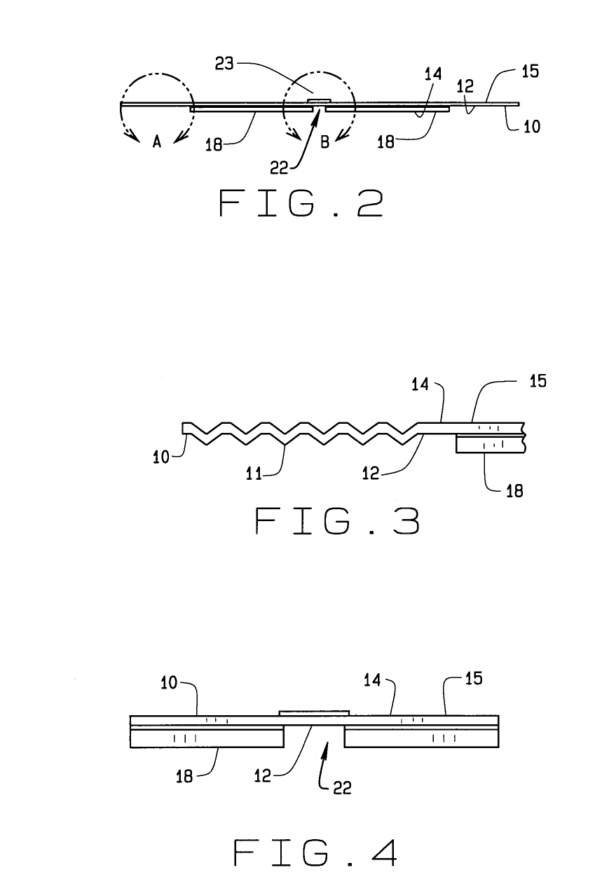

The strips 18 are preferably spaced apart to define a gap 22 therebetween and are offset from the raised nodules 11 of the base layer 10. Most preferably, the gap aligns with the longitudinal centerline of the tape and provides a relatively flexible hinge so that the tape may be bent or folded along the gap so as to be able to apply the tape to corners and angles. Preferably the strips 18 cover no more than 75% of the base layer and no less than 50% of the base layer and most preferably cover about 66% of the base layer 10. Applied to the top surface 14 of the tape 10 is a thin protective strip 23, preferably a hot melt urethane material (shown in exaggerated thickness in FIG. 2), although a hot melt polyamid could be used. The protective strip is flexible enough to allow the tape to be folded along the gap without the protective coating splitting or tearing.

The strips 18 are preferably made from paper based wallboard tape, although other paper or cellulosic based materials could be used. The strips 18 provide additional rigidity to the paper tape as well as enhanced resistance to water deformation so as to provide a flat, straight seam whether the tape is covering a flat seam of two adjacent pieces of wallboard (a “butt joint”) or is folded to form an inside or outside corner bead to cover the seam where two pieces of wallboard meet at an angle.

The tape 10 is typically from about 2 to about 4, preferably from about 2.0 to about 3.5, most preferably about 3, inches wide and about 0.008-0.010 inches thick. The paper strips 18 are preferable about 0.500 to 1.000 inches wide each and about 0.008 to 0.020 inches thick and separated the gap 22 which is about 0.010 to 0.060 inches wide, most preferably about 0.060 inches wide.

In a second embodiment and referring to FIG. 6, one or more additional layers of paper tape strips 100 may be implemented for increased stiffening and/or building tape thickness and strength; provided, however, that care should be taken to ensure that the additional layers do not bridge the gap. It can be understood by one of ordinary skill in the art that multiple layers of paper tape strips may be implemented to yet further increase the stiffening, including four layers, five layers, six layers, etc. Further, the additional strips 100 may be of equal or lesser widths than the strips 18, thereby overlaying all or a portion of the exposed surface of the underlying paper strip. For example, when using strips 18 of a 0.9375 inches width, the strips 100 may be about 0.5 inches wide. The additional paper tape strips 100 are preferably adhered with an adhesive which can be a ??polyamid hot melt?? or a urethane hot melt adhesive as with the strips 18. The polyamid glue typically has a thickness of 0.001-0.005 inches, and the additional strips have a thickness of about 0.009-0.010 inches.

In yet another embodiment of FIG. 7, the present invention may comprise a preformed corner bead of a defined angle by bending the tape 10 along the gap 22 (as seen in FIG. 6) and filling the gap 22 with an adhesive 102, preferably a urethane or polyamid hot melt adhesive. The adhesive 102 fills the gap 22 between the strips 100 and extends outwardly onto the strips 100.

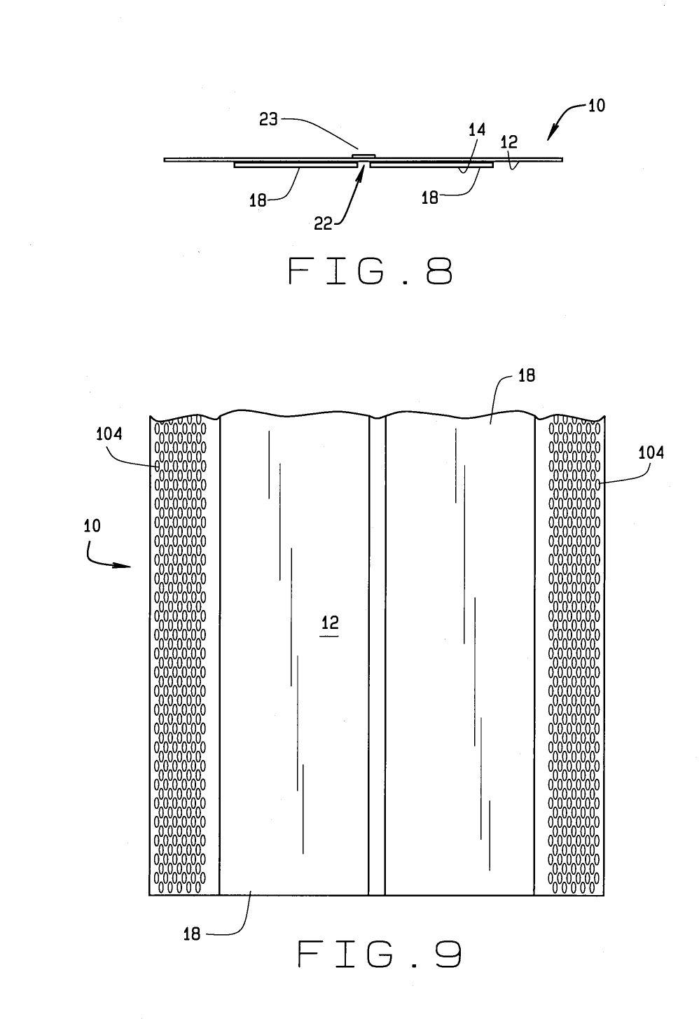

Referring to FIGS. 8 and 9, the present invention may also be applied to a wall with a water-activated/soluble glue that may be pre-applied to the upper surface of the tape which tape is activated by wetting the tape at the time of installation, thereby gluing the tape to the wallboard. The wings 15 are eliminated in this embodiment and perforations 104 are formed near the outer edges of the tape 10 to allow drywall compound to lock the tape 10 to the wall.

While the specific embodiments have been illustrated and described, numerous modifications come to mind without significantly departing from the spirit of the invention, and the scope of protection is only limited by the scope of the accompanying claims.

What is claimed is:

1. A wallboard tape comprising:
a base layer of paper tape having two parallel outer edges; and
two strips of paper tape adhered to and overlaying a portion of one surface of the base layer, said strips aligned parallel to the outer edges and being separated by a gap.

2. The wallboard tape of claim 1 wherein the gap is about 0.035 of an inch.

3. The wallboard tape of claim 1 wherein the strips cover no more than about 75% of the base layer and no less than about 50% of the base layer.

4. The wallboard tape of claim 3 wherein the strips cover about 66% of the base layer

5. The wallboard tape of claim 1 wherein the adhesive is a hot melt glue.

6. The wallboard tape of claim 1 wherein the strips are adhered with a polyamide hot melt material.

7. The wallboard tape of claim 1 wherein the strips are applied such that the wallboard tape is bilaterally symmetrical.

8. The wallboard tape of claim 1 wherein the base layer is coated with a protective strip on a side opposite the strips and directly opposite the gap.

9. The wallboard tape of claim 8 wherein the protective strip is a urethane material.

10. The wallboard tape of claim 8 wherein the protective strip is made from a material that is flexible and resists splitting when the wallboard tape is folded along a line within the gap.

11. The wallboard tape of claim 1 further comprising a pair of additional strips of paper tape overlaying at least a portion of and adhered to the two strips of paper tape.

12. The wallboard tape of claim 11 wherein the additional strips of paper tape have a width less than the width of the two strips of paper tape.

13. A wallboard tape comprising:
a base layer of paper tape having two parallel outer edges;
two strips of paper tape adhered to the base layer and parallel to the outer edges with an adhesive, the strips being separated by a gap; and
a protective strip applied to the base layer on a side opposite the strips and directly opposite the gap.

14. The wallboard tape of claim 13 wherein the gap is about 0.035 of an inch.

15. The wallboard tape of claim 13 wherein the strips cover no more than about 75% of the base layer and no less than about 50% of the base layer.

16. The wallboard tape of claim 15 wherein the strips cover about 66% of the base layer

17. The wallboard tape of claim 13 wherein the adhesive is a hot melt glue.

18. The wallboard tape of claim 13 wherein the strips are adhered with a polyamide hot melt material.

19. The wallboard tape of claim 13 wherein the strips are applied such that the base layer and the strips are bilaterally symmetrical.

20. The wallboard tape of claim 13 wherein the protective strip is a urethane material.

21. The wallboard tape of claim 13 wherein the protective strip is made from a material that is flexible and resists splitting when the wallboard tape is folded along a line within the gap.

22. The wallboard tape of claim 13 further comprising one or more pairs of additional strips of paper tape overlaying at least a portion of and adhered to the two strips of paper tape.

23. The wallboard tape of claim 22 wherein the additional strips of paper tape have a width less than the width of the two strips of paper tape.

24. The wallboard tape of claim 13 further comprising nodules formed along the base layer of paper tape and adjacent to the strips.

25. The wallboard tape of claim 13 wherein a surface of the base tape opposite the strips is coating with a water-activated adhesive.

26. The wallboard tape of claim 25 further defining a plurality of perforations adjacent an outer edge of the wallboard tape.

27. A preformed corner bead comprising:
a base layer of paper tape having two parallel outer edges; and
two strips of paper tape adhered to and overlaying a portion of one surface of the base layer, said strips aligned parallel to the outer edges and being separated by a gap; and
wherein the based layer of tape is preformed to generally a 90 degree angle.

28. The wallboard tape of claim 27 wherein the strips cover no more than about 75% of the base layer and no less than about 50% of the base layer.

29. The wallboard tape of claim 27 wherein the base layer is coated with a protective strip on a side opposite the strips and directly opposite the gap.

30. The wallboard tape of claim 27 further comprising a pair of additional strips of paper tape overlaying at least a portion of and adhered to the two strips of paper tape.

31. The wallboard tape of claim 30 wherein the additional strips of paper tape have a width less than the width of the two strips of paper tape.
